(19) United States
(12) Patent Application Publication
(10) Pub. No.: US 2009/0139986 A1
(43) Pub. Date: Jun. 4, 2009

(54) Induction heating cooker and control method thereof

(75) Inventors: Sung Ho Lee, Suwon-si (KR); Seok Weon Hong, Yongin-si (KR); Seong Deog Jang, Suwon-si (KR); Dae Rae Kim, Hwaseong-si (KR); Se Min Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/222,662

(22) Filed: Aug. 13, 2008

(30) Foreign Application Priority Data
Dec. 3, 2007 (KR) 10-2007-0124097

(51) Int. Cl. H05B 6/12

(52) U.S. Cl. 219/622; 219/625; 219/626; 219/671; 219/663; 219/672

(57) ABSTRACT

An induction heating cooker and a control method thereof. The induction heating cooker includes a plurality of heating coil groups, each of the heating coil groups including a plurality of heating coils connected in series, a plurality of inverters to individually supply high-frequency voltages to the heating coil groups, respectively, and a controller to control operations of the inverters such that the high-frequency voltages are supplied to the heating coil groups, respectively, based on the numbers of heating coils upon which at least one cooking container is placed within the respective heating coil groups. Therefore, it is possible to effectively heat the cooking container even though the container is put on any position of a cooking plate irrespective of a specific position of the cooking plate. Also, it is possible to effectively heat the container regardless of the size of the container.

### CROSS-REFERENCE TO RELATED APPLICATIONS

This application claims the benefit of Korean Patent Application No. 2007-0124097, filed on Dec. 3, 2007 in the Korean Intellectual Property Office, the disclosure of which is incorporated herein by reference.

### BACKGROUND

1. Field

Embodiments of the present invention relate to an induction heating cooker and a control method thereof, and, more particularly, to an induction heating cooker which is capable of heating a cooking container irrespective of the position of the container, and a control method thereof.

2. Description of the Related Art

In general, an induction heating cooker is an appliance that applies high-frequency current to a heating coil to generate a strong high-frequency magnetic field in the heating coil, thereby generating an eddy current in a cooking container magnetically coupled with the heating coil through the magnetic field, thus heating the container with joule heat generated due to the eddy current to cook food in the container.

In the induction heating cooker, an inverter acts to apply the high-frequency current to the heating coil. The inverter drives a switching element, which is typically composed of an Insulated Gate Bipolar Transistor (IGBT), to apply the high-frequency current to the heating coil so as to generate the high-frequency magnetic field in the heating coil.

The induction heating cooker generally includes a body casing, in which a heating device is fixedly installed to provide a heat source. In addition, a cooking plate is mounted on the top of the body casing to allow the cooking container to be put thereon. A mark is indicated at a position of the cooking plate corresponding to the heating device to enable the user to put the container accurately thereon.

However, such a conventional induction heating cooker is disadvantageous in that the user has the inconvenience of having to put a cooking container accurately on a specific position of a cooking plate.

### SUMMARY

Therefore, it is an aspect of the invention to provide an induction heating cooker which is capable of effectively heating a cooking container irrespective of the position and size of the container on a cooking plate, and a control method thereof.

Additional aspects and/or advantages will be set forth in part in the description which follows and, in part, will be apparent from the description, or may be learned by practice of the invention.

In accordance with one aspect of embodiments of the present invention, there is provided an induction heating cooker including a plurality of heating coil groups, each of the heating coil groups including a plurality of heating coils connected in series, a plurality of inverters to individually supply high-frequency voltages to the heating coil groups, respectively, and a controller to control operations of the inverters such that the high-frequency voltages are supplied to the heating coil groups, respectively, based on the numbers of heating coils on which at least one cooking container is located in the respective heating coil groups.

The heating coil groups may be arranged in parallel under a cooking plate and spaced at regular intervals.

The induction heating cooker may further comprise a plurality of sensors to sense values of currents flowing to the heating coil groups, respectively, wherein the controller determines the number of the heating coils on which the container is located in each of the heating coil groups, based on the current value sensed through a corresponding one of the sensors.

The controller may pre-store, therein, the number of the heating coils on which the container is located in each of the heating coil groups, such that it corresponds to the current value sensed through the corresponding sensor.

The induction heating cooker may further comprise a plurality of sensors to sense values of currents being supplied to the inverters, respectively, wherein the controller determines the number of the heating coils on which the container is located in each of the heating coil groups, based on the current value sensed through a corresponding one of the sensors.

The controller may pre-store, therein, the number of the heating coils on which the container is located in each of the heating coil groups, such that it corresponds to the current value sensed through the corresponding sensor.

The controller may increase and supply a corresponding one of the high-frequency voltages to a heating coil group in which the number of heating coils on which the container is located is larger, among the heating coil groups.

In accordance with another aspect of embodiments of the present invention, there is provided an induction heating cooker including a body, a cooking plate provided on the body to allow at least one cooking container to be put thereon, a plurality of heating coil groups arranged in parallel under the cooking plate and spaced at regular intervals, each of the heating coil groups including a plurality of heating coils connected in series, and a control device to individually supply high-frequency voltages to the heating coil groups to heat the container.

The control device may include a rectifier to rectify an input alternating current (AC) voltage into a direct current (DC) voltage, a plurality of inverters to switch the DC voltage to individually supply the high-frequency voltages to the heating coil groups, respectively, a plurality of sensors to sense values of currents flowing to the heating coil groups, respectively, and a controller to determine the numbers of heating coils on which the container is located in the respective heating coil groups, respectively, based on the current values sensed through the sensors, and control operations of the inverters such that the high-frequency voltages are supplied to the heating coil groups, respectively, based on the determined numbers.

The controller may increase and supply a corresponding one of the high-frequency voltages to a heating coil group in which the number of heating coils on which the container is located is larger, among the heating coil groups.

Alternatively, the control device may include a rectifier to rectify an input AC voltage into a DC voltage, a plurality of inverters to switch the DC voltage to individually supply the high-frequency voltages to the heating coil groups, respectively, a plurality of sensors to sense values of currents being supplied to the inverters, respectively, and a controller to determine the numbers of heating coils on which the container is located in the respective heating coil groups, respectively, based on the current values sensed through the sensors, and control operations of the inverters such that the high-frequency voltages are supplied to the heating coil groups, respectively, based on the determined numbers.

The controller may increase and supply a corresponding one of the high-frequency voltages to a heating coil group in which the number of heating coils on which the container is located is larger, among the heating coil groups.

In accordance with a further aspect of embodiments of the present invention, there is provided a control method of an induction heating cooker, the induction heating cooker including a cooking plate, and a plurality of heating coil groups arranged under the cooking plate, each of the heating coil groups including a plurality of heating coils connected in series, the heating coil groups being individually supplied with high-frequency voltages, respectively, the method including determining the number of heating coils on which at least one cooking container is located in each of the heating coil groups, and supplying the high-frequency voltages to the heating coil groups, respectively, based on the determined numbers.

The determining the number of heating coils on which at least one cooking container is located may include sensing values of currents flowing to the heating coil groups, respectively, and determining the number of the heating coils on which the container is located in each of the heating coil groups, based on a corresponding one of the sensed current values.

Alternatively, the determining the number of heating coils on which at least one cooking container is located may include sensing values of currents being supplied to a plurality of inverters, respectively, the inverters individually supplying the high-frequency voltages to the heating coil groups, respectively, and determining the number of the heating coils on which the container is located in each of the heating coil groups, based on a corresponding one of the sensed current values.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a perspective view of an induction heating cooker according to an embodiment of the present invention;

FIG. 2 is a schematic block diagram of a control device of an induction heating cooker according to an embodiment of the present invention;

FIG. 3 is a detailed block diagram of the control device shown in FIG. 2;

FIG. 4 is a view showing an example in which several cooking containers are put on heating coil groups, as shown for example, in FIG. 2; and

FIG. 5 is a flowchart illustrating a control method of an induction heating cooker according to an embodiment of the present invention.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

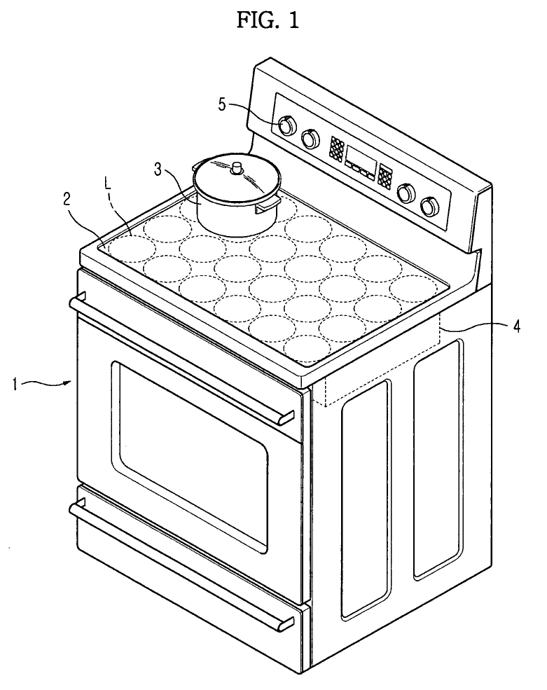

FIG. 1 is a perspective view of an induction heating cooker according to an embodiment of the present invention.

As shown in FIG. 1, the induction heating cooker according to an embodiment comprises a body casing 1.

A cooking plate 2 is mounted on the top of the body casing 1 in such a manner that a cooking container 3 can be put thereon.

A plurality of heating coils L are installed in the body casing 1 and under the cooking plate 2 to provide a heat source to the cooking plate 2. These heating coils L are arranged in, for example, four rows and six columns and spaced at regular intervals. The heating coils L are operated by a control device 4.

Also, a plurality of operating buttons 5 are provided on one side of the body casing 1 to input corresponding commands to the control device 4 to operate the heating coils L.

Therefore, the user can heat the container 3 by putting the container 3 on the cooking plate 2 and then pushing the operating buttons 5 to operate the heating coils L.

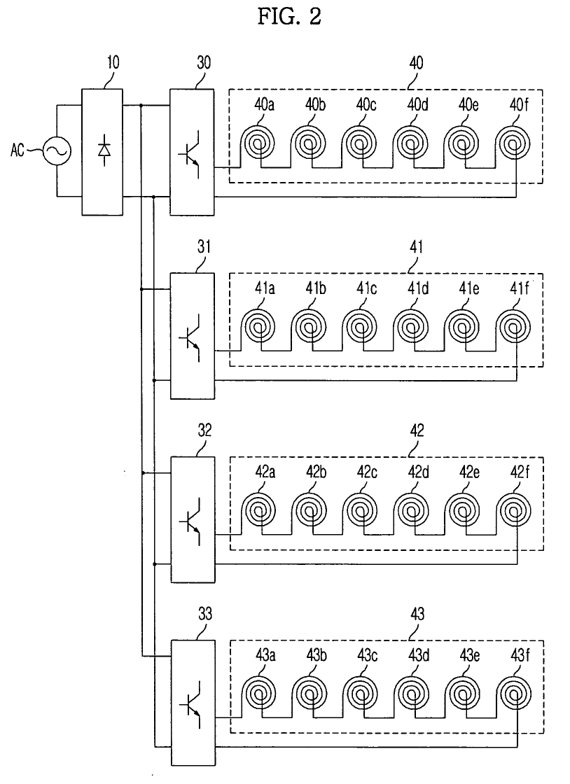

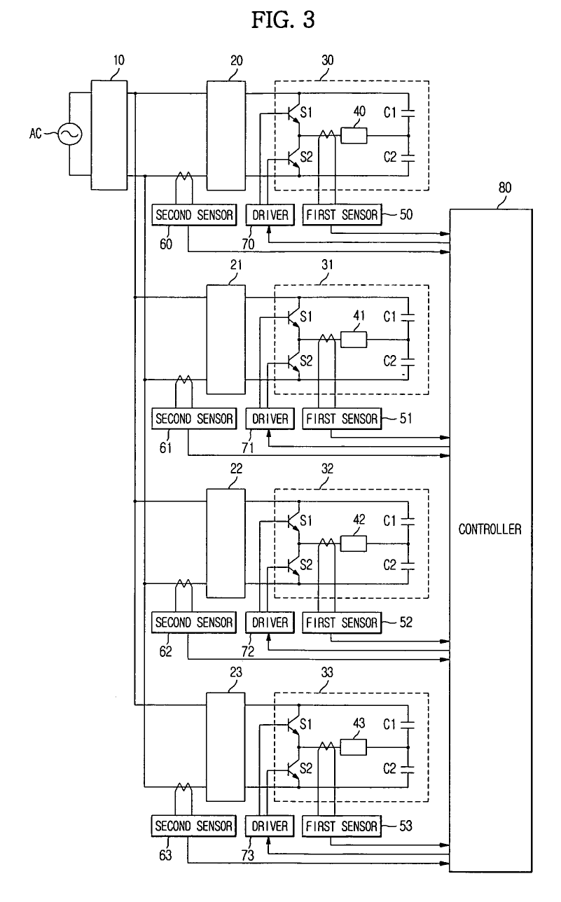

FIG. 2 is a schematic block diagram of a control device of an induction heating cooker according to an embodiment of the present invention, and FIG. 3 is a detailed block diagram of the control device, for example, as shown in FIG. 2.

Referring to FIGS. 2 and 3, the control device of the induction heating cooker according to an embodiment includes one rectifier 10, four smoothers 20 to 23, four inverters 30 to 33, four first sensors 50 to 53, four second sensors 60 to 63, four drivers 70 to 73, and a controller 80.

The rectifier 10 rectifies an input alternating current (AC) voltage into a direct current (DC) voltage and outputs the rectified DC voltage.

The smoothers 20, 21, 22 and 23 each smooth the output DC voltage from the rectifier 10 and output the resulting constant DC voltage.

The inverters 30, 31, 32 and 33 each include switching elements S1 and S2 to switch the output DC voltage from a corresponding one of the smoothers 20, 21, 22 and 23 in response to switching control signals from a corresponding one of the drivers 70, 71, 72 and 73 to provide a resonance voltage, and resonant capacitors C1 and C2 connected in series between a positive voltage terminal and a negative voltage terminal to resonate in succession with a corresponding one of heating coil groups 40, 41, 42 and 43 with the resonance voltage.

Each of the heating coil groups 40, 41, 42 and 43 is connected between the switching elements S1 and S2 and generates the resonance voltage with a high-frequency voltage to induce an eddy current in a cooking container so as to heat the container.

Each of the heating coil groups 40, 41, 42 and 43 includes, for example, six heating coils 40a to 40f, 41a to 41f, 42a to 42f or 43a to 43f connected in series and spaced at regular intervals.

When the switching element S1 of each of the inverters 30, 31, 32 and 33 conducts and the switching element S2 thereof does not conduct, a corresponding one of the heating coil groups 40, 41, 42 and 43 and the resonant capacitor C2 form a resonance circuit in series. Conversely, when the switching element S2 conducts and the switching element S1 does not conduct, the corresponding one of the heating coil groups 40, 41, 42 and 43 and the resonant capacitor C1 form a resonance circuit in series.

The drivers 70, 71, 72 and 73 each switch the switching elements S1 and S2 of a corresponding one of the inverters 30, 31, 32 and 33 in response to a control signal from the controller 80.

The first sensors 50, 51, 52 and 53 each sense the value of current flowing to a corresponding one of the heating coil groups 40, 41, 42 and 43. Preferably, each of the first sensors 50, 51, 52 and 53 includes a current transformer sensor (CT sensor).

The second sensors 60, 61, 62 and 63 each sense the value of current being supplied to a corresponding one of the inverters 30, 31, 32 and 33. Preferably, each of the second sensors 60, 61, 62 and 63 includes a current transformer sensor (CT sensor).

The controller 80 performs the entire control operation. When a cooking command is inputted, the controller 80 generates the switching control signals through each of the drivers 70, 71, 72 and 73 to alternately operate the switching elements S1 and S2. For example, when the switching element S1 conducts and the switching element S2 does not conduct, a circuit is formed which consists of the switching element S1, the heating coil group 40, 41, 42 or 43 and the resonant capacitor C2. Conversely, when the switching element S2 conducts and the switching element S1 does not conduct, a circuit is formed which consists of the resonant capacitor C1, the heating coil group 40, 41, 42 or 43 and the switching element S2. As a result, the resonance voltage based on the high-frequency voltage is provided to each of the heating coil groups 40, 41, 42 and 43. At this time, because each of the heating coil groups 40, 41, 42 and 43 and the resonant capacitors C1 and C2 enter a resonance state in succession, large resonance current flows to each of the heating coil groups 40, 41, 42 and 43.

This resonance current generates a high-frequency magnetic field in each of the heating coil groups 40, 41, 42 and 43, and eddy current is induced in the container due to electromagnetic induction by the high-frequency magnetic field, so as to heat the container. As a result, desired cooking is carried out by heating food in the container.

On the other hand, the controller 80 can individually vary the high-frequency voltages to be supplied to the heating coil groups 40, 41, 42 and 43 by controlling the operations of the inverters 30 to 33 through the drivers 70 to 73, respectively. Thus, the controller 80 increases the high-frequency voltage to a heating coil group in which the number of heating coils on which the container is put is larger, among the heating coil groups 40, 41, 42 and 43, and reduces the high-frequency voltage to a heating coil group in which the number of heating coils on which the container is put is smaller, among the heating coil groups 40, 41, 42 and 43. To this end, the controller 80 determines the number of heating coils on which the container is put in each of the heating coil groups 40, 41, 42 and 43, based on the value of current sensed through a corresponding one of the first sensors 50 to 53 or second sensors 60 to 63. That is, where a container is placed upon a larger number of heating coils in a given heating coil group, current being supplied to the given heating coil group or an inverter corresponding thereto also increases proportionally to the larger number. Conversely, where a container is placed upon a smaller number of heating coils, in a given heating coil group, current being supplied to the given heating coil group or an inverter corresponding thereto also reduces proportionally to the smaller number. As a result, the numbers of heating coils corresponding respectively to various current values can be easily known by storing them in the form of a table.

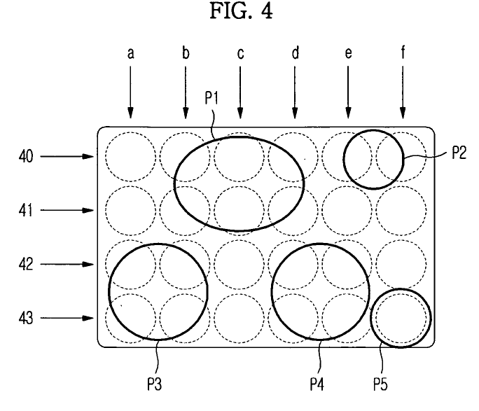

FIG. 4 shows a state where five cooking containers P1 to P5 are put on the four heating coil groups 40 to 43. As shown in FIG. 4, a portion of the first container P1 is put on the heating coils 40b, 40c and 40d in the first heating coil group 40, among the heating coil groups 40, 41, 42 and 43, and the second container P2 is put on the heating coils 40e and 40f in the first heating coil group 40. The remaining portion of the first container P1 is put on the heating coils 41b, 41c and 41d in the second heating coil group 41. Also, a portion of the third container P3 is put on the heating coils 42a and 42b in the third heating coil group 42, and a portion of the fourth container P4 is put on the heating coils 42d and 42e in the third heating coil group 42. Also, the remaining portion of the third container P3 is put on the heating coils 43a and 43b in the fourth heating coil group 43, the remaining portion of the fourth container P4 is put on the heating coils 43d and 43e in the fourth heating coil group 43, and the fifth container P5 is put on the heating coil 43f in the fourth heating coil group 43. As shown in FIG. 4, the number of heating coils on which containers are located in the first heating coil group 40 is five, the number of heating coils on which a container is located in the second heating coil group 41 is three, the number of heating coils on which containers are located in the third heating coil group 42 is four, and the number of heating coils on which containers are located in the fourth heating coil group 43 is five. At this time, the number of heating coils on which a container is located in each of the heating coil groups 40, 41, 42 and 43 can be known based on a sensed current value corresponding to each of the heating coil groups 40, 41, 42 and 43.

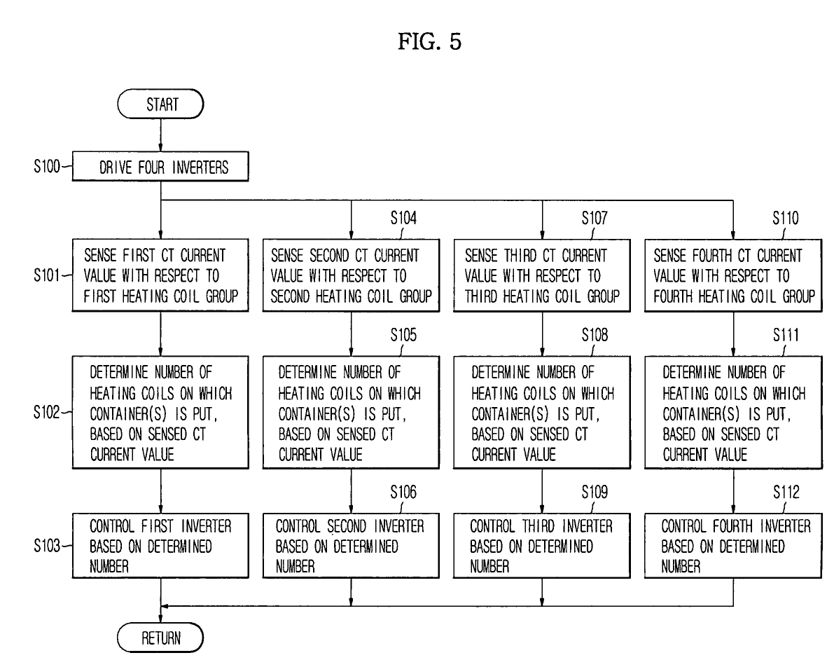

FIG. 5 is a flowchart illustrating a control method of an induction heating cooker according to an embodiment of the present invention.

Hereinafter, the control method of the induction heating cooker according to an embodiment shown in FIG. 5 will be described with reference to FIG. 4. For the convenience of description, it is assumed that the output power of each of the heating coils in FIG. 4 is 500 W.

Referring to FIG. 5, first, at operation S100, the controller 80 drives the four inverters 30 to 33 through the drivers 70 to 73, respectively.

After driving the four inverters 30 to 33, the controller 80 senses the value of a first current flowing to the first heating coil group 40 or being supplied to the first inverter 30 through the first sensor 50 or second sensor 60, with respect to the first heating coil group 40, at operation S101.

After sensing the first current value, the controller 80 determines the number of heating coils on which containers have been placed, based on the sensed first current value, at operation S102.

After determining the number of heating coils, the controller 80 controls the operation of the first inverter 30 through the first driver 70 based on the determined number at operation S103 to adjust a high-frequency voltage to the first heating coil group 40 to a value appropriate to the determined number.

At this time, because the number of heating coils on which containers are located in the first heating coil group 40 is five as shown in FIG. 4, the controller 80 controls the operation of the first inverter 30 through the first driver 70 to apply a high-frequency voltage corresponding to 2500 W (500 W*5) to the first heating coil group 40.

Also, after driving the four inverters 30 to 33, the controller 80 senses the value of a second current flowing to the second heating coil group 41 or being supplied to the second inverter 31 through the first sensor 51 or second sensor 61, with respect to the second heating coil group 41, at operation S104.

After sensing the second current value, the controller 80 determines the number of heating coils on which containers have been placed, based on the sensed second current value, at operation S105.

After determining the number of heating coils, the controller 80 controls the operation of the second inverter 31 through the second driver 71 based on the determined number at operation S106 to adjust a high-frequency voltage to the second heating coil group 41 to a value appropriate to the determined number.

At this time, because the number of heating coils on which a container is located in the second heating coil group 41 is three as shown in FIG. 4, the controller 80 controls the operation of the second inverter 31 through the second driver 71 to apply a high-frequency voltage corresponding to 1500 W (500 W*3) to the second heating coil group 41.

Also, after driving the four inverters 30 to 33, the controller 80 senses the value of a third current flowing to the third heating coil group 42 or being supplied to the third inverter 32 through the first sensor 52 or second sensor 62, with respect to the third heating coil group 42, at operation S107.

After sensing the third current value, the controller 80 determines the number of heating coils on which containers have been placed, based on the sensed third current value, at operation S108.

After determining the number of heating coils, the controller 80 controls the operation of the third inverter 32 through the third driver 72 based on the determined number at operation S109 to adjust a high-frequency voltage to the third heating coil group 42 to a value appropriate to the determined number.

At this time, because the number of heating coils on which containers are located in the third heating coil group 42 is four as shown in FIG. 4, the controller 80 controls the operation of the third inverter 32 through the third driver 72 to apply a high-frequency voltage corresponding to 2000 W (500 W*4) to the third heating coil group 42.

Also, after driving the four inverters 30 to 33, the controller 80 senses the value of a fourth current flowing to the fourth heating coil group 43 or being supplied to the fourth inverter 33 through the first sensor 53 or second sensor 63, with respect to the fourth heating coil group 43, at operation S110.

After sensing the fourth current value, the controller 80 determines the number of heating coils on which containers have been placed, based on the sensed fourth current value, at operation S111.

After determining the number of heating coils, the controller 80 controls the operation of the fourth inverter 33 through the fourth driver 73 based on the determined number at operation S112 to adjust a high-frequency voltage to the fourth heating coil group 43 to a value appropriate to the determined number.

At this time, because the number of heating coils on which containers are located in the fourth heating coil group 43 is five as shown in FIG. 4, the controller 80 controls the operation of the fourth inverter 33 through the fourth driver 73 to apply a high-frequency voltage corresponding to 2500 W (500 W*5) to the fourth heating coil group 43.

As is apparent from the above description, according to embodiments of the present invention, it is possible to effectively heat a cooking container even though the container is put on any position of a cooking plate irrespective of a specific position of the cooking plate. Also, it is possible to effectively heat the container regardless of the size of the container.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An induction heating cooker comprising:
a plurality of heating coil groups, each of the heating coil groups including a plurality of heating coils connected in series;
a plurality of inverters to individually supply high-frequency voltages to the heating coil groups, respectively; and
a controller to control operations of the inverters such that the high-frequency voltages are supplied to the heating coil groups, respectively, based on numbers of heating coils upon which at least one cooking container is placed within the respective heating coil groups.

2. The induction heating cooker according to claim 1, wherein the heating coil groups are arranged in parallel under a cooking plate and spaced at regular intervals.

3. The induction heating cooker according to claim 1, further comprising a plurality of sensors to sense values of currents flowing to the heating coil groups, respectively, wherein the controller determines the number of heating coils upon which the container is placed within each of the heating coil groups, based on the current value sensed through a corresponding one of the sensors.

4. The induction heating cooker according to claim 3, wherein the corresponding one of the sensors corresponds with one of the heating coil groups.

5. The induction heating cooker according to claim 3, wherein the controller pre-stores, therein, the number of the heating coils on which the container is located in each of the heating coil groups, such that it corresponds to the current value sensed through the corresponding sensor.

6. The induction heating cooker according to claim 1, further comprising a plurality of sensors to sense values of currents being supplied to the inverters, respectively, wherein the controller determines the number of the heating coils upon which the at least one container is placed within each of the heating coil groups, based on the current value sensed through a corresponding one of the sensors.

7. The induction heating cooker according to claim 6, wherein the controller pre-stores, therein, the number of the heating coils upon which the at least one container is placed within each of the heating coil groups, such that the number of heating coils corresponds to the current value sensed through the corresponding sensor.

8. The induction heating cooker according to claim 1, wherein the controller increases and supplies a corresponding one of the high-frequency voltages to one of the heating coil groups in which the number of heating coils upon which the at least one container is placed is larger, among the heating coil groups.

9. An induction heating cooker comprising:
a body;
a cooking plate provided on the body to allow at least one cooking container to be placed thereon;
a plurality of heating coil groups arranged in parallel under the cooking plate and spaced at regular intervals, each of the heating coil groups including a plurality of heating coils connected in series; and
a control device to individually supply high-frequency voltages to the heating coil groups to heat the container.

10. The induction heating cooker according to claim 9, wherein the control device comprises:
a rectifier to rectify an input alternating current (AC) voltage into a direct current (DC) voltage;
a plurality of inverters to switch the DC voltage to individually supply the high-frequency voltages to the heating coil groups, respectively;
a plurality of sensors to sense values of currents flowing to the heating coil groups, respectively; and
a controller to determine numbers of heating coils upon which the at least one cooking container is placed within the respective heating coil groups, respectively, based on the current values sensed through the sensors, and to control operations of the inverters such that the high-frequency voltages are supplied to the heating coil groups, respectively, based on the determined numbers.

11. The induction heating cooker according to claim 10, wherein the controller increases and supplies a corresponding one of the high-frequency voltages to one of the heating coil groups in which the number of heating coils upon which the container is placed is larger, among the heating coil groups.

12. A control method of an induction heating cooker, the induction heating cooker including a cooking plate, and a plurality of heating coil groups arranged under the cooking plate, each of the heating coil groups including a plurality of heating coils connected in series, the heating coil groups being individually supplied with high-frequency voltages, respectively, the method comprising:
determining a number of heating coils upon which at least one cooking container is placed for each of the heating coil groups; and
supplying the high-frequency voltages to the heating coil groups, respectively, based on the respective determined number of heating coils for each of the heating coil groups.

13. The control method according to claim 12, wherein the determining comprises:
sensing values of currents flowing to the heating coil groups, respectively; and
determining the number of the heating coils upon which the at least one cooking container is placed for each of the heating coil groups, based on a corresponding one of the sensed current values.

14. The control method according to claim 12, wherein the determining comprises:
sensing values of currents being supplied to a plurality of inverters, respectively, the inverters individually supplying the high-frequency voltages to the heating coil groups, respectively; and
determining the number of the heating coils upon which the at least one cooking container is placed for each of the heating coil groups, based on a corresponding one of the sensed current values.

15. A method of induction heating comprising:
determining, for each of a plurality of heating coil groups, a number of heating coils within each heating coil group generating an eddy current; and
supplying an amount of high-frequency voltage to the heating coil groups, respectively, based on the determined number of heating coils for each of the heating coil groups.

16. The method according to claim 15 wherein the determining comprises:
sensing an amount of current applied to each heating coil group; and
determining, for each of the heating coil groups, the number of heating coils generating an eddy current in an adjacent cooking container based on the corresponding sensed amount of current applied to each heating coil group.

17. The method according to claim 16 wherein the sensing is performed through a set of sensors, each sensor sensing an amount of current flowing to one of the heating coil groups.

18. The method according to claim 16 wherein the sensing is performed though a set of sensors, each sensor sensing an amount of current being supplied to an inverter, the inverter corresponding with and supplying a high-frequency voltage to each of the heating coil groups.
